SEQUENCE LISTING (14 sequences)

SEQ ID NO: 1 - DNA, 26 bp, Artificial Sequence
  synthetic oligonucleotide
ttttttttttttttttttactgattt

SEQ ID NO: 2 - DNA, 11 bp, Artificial Sequence
  synthetic oligonucleotide
ccagggtatcc

SEQ ID NO: 3 - DNA, 24 bp, Artificial Sequence
  synthetic oligonucleotide
ggcaaacgccacagctccaaacgg

SEQ ID NO: 4 - DNA, 6 bp, Artificial Sequence
  synthetic oligonucleotide
aaaaaa

SEQ ID NO: 5 - DNA, 12 bp, Artificial Sequence
  synthetic oligonucleotide
aaaaaaaaaaaa

SEQ ID NO: 6 - DNA, 18 bp, Artificial Sequence
  synthetic oligonucleotide
aaaaaaaaaaaaaaaaaa

SEQ ID NO: 7 - DNA, 13 bp, Artificial Sequence
  synthetic oligonucleotide
acacacaacacac

SEQ ID NO: 8 - DNA, 6 bp, Artificial Sequence
  synthetic oligonucleotide
cccccc

SEQ ID NO: 9 - DNA, 12 bp, Artificial Sequence
  synthetic oligonucleotide
cccccccccccc

SEQ ID NO: 10 - DNA, 18 bp, Artificial Sequence
  synthetic oligonucleotide
cccccccccccccccccc

SEQ ID NO: 11 - DNA, 25 bp, Artificial Sequence
  synthetic oligonucleotide
ttttttttttttttttttactgatt

SEQ ID NO: 12 - DNA, 6 bp, Artificial Sequence
  synthetic oligonucleotide
tttttt

SEQ ID NO: 13 - DNA, 12 bp, Artificial Sequence
  synthetic oligonucleotide
tttttttttttt

SEQ ID NO: 14 - DNA, 18 bp, Artificial Sequence
  synthetic oligonucleotide
tttttttttttttttttt

(19) United States
(12) Patent Application Publication
(10) Pub. No.: US 2015/0177181 A1
(43) Pub. Date: Jun. 25, 2015

(54) ELECTROCHEMICAL SENSORS AND METHODS OF USING

(71) Applicant: NUtech Ventures, Lincoln, NE (US)

(72) Inventor: Rebecca Y. Lai, Lincoln, NE (US)

(21) Appl. No.: 14/563,145

(22) Filed: Dec. 8, 2014

Related U.S. Application Data
(60) Provisional application No. 61/912,587, filed on Dec. 6, 2013.

(51) Int. Cl. G01N 27/327

(52) U.S. Cl. CPC G01N 27/3277

(57) ABSTRACT

Electrochemical sensors are provided, as are methods of using such electrochemical sensors for detecting ions.

### CROSS REFERENCE TO RELATED APPLICATIONS

This application claims benefit under 35 U.S.C. §119(e) to U.S. Application No. 61/912,587 filed on Dec. 6, 2013.

### FEDERALLY SPONSORED RESEARCH OR DEVELOPMENT

This invention was made with government support under CHE-0955439 awarded by the National Science Foundation. The government has certain rights in the invention.

### TECHNICAL FIELD

This disclosure generally relates to electrochemical sensors and methods of using.

### BACKGROUND

The use of electrochemical sensors in the medical field for testing various blood or urine analytes and in the environmental field for monitoring water or soil contamination is well known. The present disclosure describes electrochemical sensors that can be used in the detection of ions (e.g., metal ions).

### SUMMARY

In one aspect, an electrochemical sensor for detecting the presence or absence of ions is provided. Typically, the sensor includes a substrate that includes at least one working electrode; a reference electrode; and a counter electrode. Typically, each of the at least one working electrode includes an ion sensing probe that, in turn, includes a redox indicator. In some embodiments, the ion is selected from the group consisting of Hg²⁺, Cu²⁺, Mg²⁺, Ca²⁺, Zn²⁺, Ni²⁺, CO²⁺, Cr⁶⁺, Pb²⁺, Mn²⁺, Mo⁶⁺, Au³⁺, Pt²⁺, Se⁴⁺, As³⁺, Fe²⁺, Fe³⁺, Al³⁺ or Ag⁺. Representative ion sensing probes include, without limitation, nucleic acids, aptamers, and polypeptides.

In some embodiments, the redox indicator is methylene blue. In some embodiments, the at least one working electrode comprises gold. In some embodiments, the reference electrode comprises silver. In some embodiments, the counter electrode comprises platinum. In some embodiments, the substrate is paper.

In another aspect, a method of detecting the presence or absence of an ion in a sample is provided. Such a method typically includes contacting an electrochemical sensor as described herein with a sample; and obtaining electrochemical measurements to determine whether or not a change in redox potential occurs. Representative electrochemical measurements include, without limitation, alternating current voltammetry (ACV), cyclic voltammetry (CV), square wave voltammetry (SWV), and differential pulse voltammetry (DPV).

In some embodiments, the sensor is a signal-on sensor; a change in the redox potential is indicative of the presence of the ion, and no change in the redox potential is indicative of the absence of the ion. In some embodiments, the sensor is a signal-off sensor; no change in the redox potential is indicative of the presence of the ion, and a change in the redox potential is indicative of the absence of the ion.

In some embodiments, the one or more electrodes are screen-printed onto the substrate. Representative samples include, without limitation, an environmental sample, a food sample, and a biological sample. In some embodiments, the environmental sample is a soil sample. In some embodiments, the food sample is fish. In some embodiments, the biological sample is a blood sample.

Unless otherwise defined, all technical and scientific terms used herein have the same meaning as commonly understood by one of ordinary skill in the art to which the methods and compositions of matter belong. Although methods and materials similar or equivalent to those described herein can be used in the practice or testing of the methods and compositions of matter, suitable methods and materials are described below. In addition, the materials, methods, and examples are illustrative only and not intended to be limiting. All publications, patent applications, patents, and other references mentioned herein are incorporated by reference in their entirety.

### DESCRIPTION OF DRAWINGS

FIG. 1 are graphs of AC voltammograms (A) and CV scans (C) of the sensor recorded in the absence or presence of 1 μM Hg²⁺, and after sensor regeneration. Also shown are graphs of AC frequency-dependent (B) and CV scan rate-dependent (D) MB currents before and after Hg²⁺ binding, and after sensor regeneration. The inset in panels B and D shows the % SS as a function of the applied frequency or voltammetric scan rate.

FIG. 2 are graphs of SWV (A) and DPV (C) scans of the sensor recorded in the absence or presence of 1 μM Hg²⁺, and after sensor regeneration. Also shown are graphs of SWV frequency-dependent (B) and DPV pulse width-dependent (D) MB currents before and after Hg²⁺ binding, and after sensor regeneration. The inset in panels B and D shows the % SE as a function of the applied frequency or pulse width.

FIG. 3 is a graph showing a dose-response curve obtained in ACV at 10 Hz in PBS. The Hg²⁺ concentrations used were 10, 50, 100, 500, 1000, 2000, and 3000 nM. The results were averaged from three different sensors. The inset shows the voltammograms collected before and after addition of various concentrations of Hg²⁺.

FIG. 4 are graphs showing the sensor's responses to 10 μM Mg²⁺, Ca²⁺, Zn²⁺, Ni²⁺, Co²⁺, Cr²⁺, Pb²⁺, Ag⁺ and 1 μM Hg²⁺ when interrogated using ACV and CV (A). Also shown are the sensor's responses when SWV and DPV were used (B).

FIG. 5 is a graph showing AC voltammograms of the sensor fabricated on a gold-plated screen-printed carbon electrode in the absence or presence of 5 μM Hg²⁺, and after sensor regeneration via a 4-min incubation in 0.5 M HCl. The inset shows a photograph of the actual electrode used in the experiment.

FIG. 6 is a schematic of the T18-LP DNA probe used in this study.

FIG. 7 is a graph showing the time-dependent sensor response to 1 μM Hg²⁺ in PBS. These data were collected at 10 Hz in ACV.

FIG. 8 is a graph showing an interrogation-regeneration plot for the Hg²⁺ sensor. These data were collected at 10 Hz in ACV in PBS. The target concentration was 1 μM.

FIG. 9 are voltammograms recorded using ACV at different frequencies (A-C), using CV at different scan rates (D-F), using SWV at different frequencies (G-I), and using DPV at different pulse widths (J-L). Overall, the sensor is operational under a wide range of experimental conditions; both the signalling motive and extent of signal change are highly dependent on one parameter for each electrochemical interrogation technique (frequency for ACV; scan rate for CV; frequency for SWV; and pulse width for DPV).

FIG. 10 are graphs showing that interference from Cu²⁺ can be eliminated by the addition of a Cu²⁺-binding reagent such as a single stranded DNA (TS-11). Shown are % SS and % SE obtained in ACV and SWV in the presence of 10 μM TS-11, 10 μM TS-11 with 10 μM Cu²⁺, and after the addition of 1 μM Hg²⁺.

FIG. 11 are graphs showing that the sensor is selective enough to be used in realistically complex media such as soil extract and tuna extract. Shown are the sensor's responses to 10 μM Hg²⁺ when interrogated directly in the complex samples using ACV and SWV.

FIG. 12 shows the custom-built electrochemical cell that was used in sensor interrogation (Panel A) and the gold-plated Pine Research and CH Instruments SPC electrodes used in this study (Panel B). Panel C shows AC voltammograms of the sensor fabricated on a gold-plated Pine Research SPC electrode in the absence or presence of 5 μM Hg²⁺, and after sensor regeneration using 0.5 M HCl.

FIG. 13 is data from a copper ion sensor. Panel A is a schematic of the sensor construct, and Panel B shows the response of the sensor.

FIG. 14 is data from a silver ion sensor. Panel A is a schematic of the sensor construct, and Panel B shows the response of the sensor.

FIG. 15 is data from a mercury ion sensor. Panel A is a schematic of the sensor construct, and Panel B shows the response of the sensor.

FIG. 16 is data from a chromium ion sensor. Panel A is a schematic of the sensor construct, and Panel B shows the response of the sensor.

### DETAILED DESCRIPTION

Electrochemical sensors are well known in the art. Simply by way of example, see U.S. Pat. Nos. 4,019,974; 4,271,000; 4,776,942; 5,418,142; 5,951,836; 6,432,723 and US 2007/0020641. The electrochemical sensors described herein can be used to detect one or more metal ions in a sample. The sensors described herein can detect any number of metal ions including, without limitation, Hg²⁺, Cu²⁺, Mg²⁺, Ca²⁺, Zn²⁺, Ni²⁺, Co²⁺, Cr³⁺, Cr⁶⁺, Pb²⁺, Mn²⁺, Mo⁶⁺, Au³⁺, Pt²⁺, Se⁴⁺, As³⁺, Fe²⁺, Fe³⁺, Al³⁺ or Ag⁺ ions. The sensors described herein can be reusable and/or disposable.

Typically, a sensor as described herein includes a working electrode (WE), a counter electrode (CE) and a reference electrode (RE) attached to a substrate. It would be understood, however, that a sensor also can include a working electrode (WE) and a reference electrode (RE), which also acts as the counter electrode, attached to a substrate 108. A substrate can be made from any number of materials including, without limitation, paper, plastic, ceramic, or glass.

Electrodes can be made from any number of materials, including, for example, gold, platinum, silver, carbon, graphene or other graphitic material, indium tin oxide, or polymer-modified material (e.g., conducting polymer-modified material). The particular material(s) used to fabricate the electrodes generally are selected based upon the particular application (e.g., the sample to which the electrochemical sensor will be exposed). In one embodiment, the WE includes gold (e.g., a gold-plated electrode), the CE includes platinum (e.g., platinum wire), and the RE includes silver (e.g., silver/silver chloride).

In some embodiments, one or more of the electrodes are screen-printed onto a substrate using conductive inks (e.g., silver, gold, carbon, dielectric polymer, or nickel). In some embodiments, one or more metals can be applied to an electrode or a sensor using electrodeposition or electroplating. For example, platinum, silver, nickel, palladium, gold, silver, copper, iridium, rhodium, or mercury can be electrodeposited or electroplated onto a WE.

A sensor as described herein further includes an ion sensing probe. Generally, an ion sensing probe is covalently attached to the working electrodes. As used herein, an ion sensing probe refers to a molecule that is used to detect or facilitate detection of the target ion. As will be appreciated by a skilled artisan, the particular type of probe will depend on the target ion being detected. Several different ion sensing probes are disclosed and used herein to detect several different ions; others can be readily designed using known techniques. Methods of attaching an ion sensing probe to a working electrode are well-known in the art and include, without limitation, covalent linkers or sulfur groups (e.g., thiols).

An ion sensing probe can be a nucleic acid. Nucleic acids are well known in the art and include DNA molecules and RNA molecules as well as DNA or RNA molecules containing one or more nucleotide analogs. Nucleic acids used in electrochemical sensors can be single-stranded or double-stranded, which is generally dictated by its intended use. Nucleic acids used in electrochemical sensors as described herein typically are at least 9 nucleotides in length (e.g., at least 10, 12, 15, 18, 20, 25, 30, 40, 50, 75, 80, or 95 nucleotides in length) and can be as many as one or several hundred bases in length (e.g., 100 bp, 350 bp, 500 bp, 800 bp, or 950 bp) or more. In certain embodiments, nucleic acids used in electrochemical sensors can be about 9 bp-about 1 kb, about 9 bp-about 500, about 9 aa-about 200 aa, about 20 bp-about 500 bp, about 20 bp-about 200 bp, about 20 bp-about 50 bp, about 25 bp-about 100 bp, about 25 bp-about 250 bp, or about 50 bp-about 1 kb in length. Methods of making or obtaining nucleic acids are routine to those skilled in the art. Representative methods of making or obtaining (e.g., isolating) nucleic acids include, for example, chemical synthesis, cloning, or PCR amplification.

An ion sensing probe also can be a polypeptide. Polypeptides are well known in the art and refer to multiple amino acids or amino acid analogues joined by peptide bonds. Polypeptides used in electrochemical sensors as described herein can be at least about 3 amino acids (aa) in length (e.g., at least about 5 aa, 7 aa, 10 aa, 12 aa, 15 aa, 20 aa, 25 aa, 30 aa, 40 aa, 50 aa, 60 aa, 70 aa, 80 aa, 90 aa, or 95 aa in length), at least about 100 aa in length (e.g., at least about 125 aa, 200 aa, 250 aa, 375 aa, 500 aa, 650 aa, 725 aa, 875 aa, or 900 aa in length), or more. For example, polypeptides can be about 10 aa-about 500 aa, about 20 aa-about 100 aa, about 25 aa-about 50 aa, about 3 aa-about 15 aa, about 3 aa-about 10 aa, about 5 aa-about 12 aa, or about 8 aa-15 aa in length. Polypeptides can be obtained (e.g., purified) from natural sources (e.g., a biological sample) using known methods such as DEAE ion exchange, gel filtration, and hydroxyapatite chromatography. Polypeptides also can be obtained by expressing a nucleic acid (e.g., from an expression vector), or by chemical synthesis.

An ion sensing probe alternatively can be an aptamer. Aptamers also are well known in the art and include nucleic acids (e.g., oligonucleotides) and polypeptides. Aptamers refer to nucleic acids or polypeptides that bind to a specific target molecule, and typically are obtained by selection from a large random-sequence pool. However, natural aptamers also exist. Nucleic acid aptamers or polypeptide aptamers can be used in the electrochemical sensors described herein.

To facilitate detection of one or more ions, the ion sensing probe typically includes a redox indicator. Redox indicators are well known in the art and include, without limitation, purely organic redox indicators, such as viologen, ethidium bromide, daunomycin, methylene blue, and their derivatives, organo-metallic redox labels, such as ferrocene, ruthenium, bis-pyridine, tris-pyridine, osmium tris-bipyridine, cobalt tris-bipyridine, bis-imidizole, and their derivatives, and labels such as oxazine and derivatives thereof (e.g., ifosfamide and tetrahydro-1,4-oxazine). Additional redox indicators include 2,6-dibromophenol-indophenol, indigotetrasulfonic acid, indigotrisulfonic acid, indigodisulfonic acid, indigomono sulfonic acid, safranin, phenosafranin, phenylanthranilic acid, ethoxychrysoidine, dianisidinee, diphenylamine sulfonate, diphenylbenzidine, and diphenylamine. It would be understood that suitable redox indicators are those possessing a redox potential that is at least as positive as MB.

Although not wishing to be bound by any particular mechanism, it is expected that binding of metal ions to an ion sensing probe (e.g., a nucleic acid, a polypeptide, or an aptamer) changes the flexibility of the probe. Such a change in the flexibility of the ion sensing probe then results in a detectable change in the redox indicator. As discussed herein, the particular change that occurs in the redox indicator is dependent upon the type of electrochemical interrogation applied and whether the electrochemical sensor is a signal-on sensor or a signal-off sensor under those particular electrochemical interrogation conditions, in addition to the specific characteristics of the redox indicator itself.

In some embodiments, metal ions having high oxidation states (e.g., Cr⁶⁺ and Mo⁶⁺) can be detected by direct reaction with a reduced redox indicator (e.g., a redox indicator having a reduction potential at least or more positive than methylene blue). The reaction can include electrochemical reduction of the redox indicator to prepare a reduced form of the indicator followed by reaction of the reduced redox indicator with a metal ion. Reaction with the metal ion reduces the metal ion and oxidizes the redox indicator allowing the indicator to be detected using known methods. For example, methylene blue (MB) can be electrochemically reduced to leucomethylene blue (LB), the reduced form of MB. The LB can then react with a high oxidation state metal ion (e.g., Cr⁶⁺) to reduce the metal ion (e.g., to Cr³⁺) and oxidize the LB back to MB.

The electrochemical sensors described herein can be used to determine whether or not a target ion is present in a sample. Samples can be biological samples (e.g., whole blood, blood serum, plasma, saliva, urine, cell lysates, tissue digests, or cell media), environmental samples (e.g., sea water, ground water, waste water, run-off water (e.g., from farm, from industrial site), or soil samples), and food samples (e.g., milk, tissue samples, fish, meat, beer and other beverages). The electrochemical sensors described herein can be contacted with any such sample and the redox potential measured to determine whether or not the target ion is present.

The electrochemical sensors described herein can be configured as voltammetric electrochemical sensors that utilize alternating current voltammetry in a solution or buffer that includes a sample. The use of voltammetry allows control of the potential (voltage) of an electrode in contact with a sample while the resulting current is measured. For example, a voltammetric scan can obtain information about a target sample from an electrochemical sensor by measuring current at a first electrode (e.g., a working electrode), where the current results from the transfer of electrons between the electrode and the analyte. A second electrode (e.g., a reference electrode) generally is a half cell with a known reduction potential (voltage), which does not pass any current between it and the analyte and acts as a reference in measuring and controlling the potential at the first electrode. A third electrode (e.g., a counter electrode) can pass the current needed to balance the current observed at the first electrode (e.g., the counter electrode).

Alternating current voltammetry (ACV), for example, can include superimposing a small alternating voltage of a constant magnitude on a voltammetric scan. A plot of alternating current verses the voltage applied to a working electrode provides a qualitative measure of the electrode process. In some implementations, low frequency (e.g., 10 Hz.) small alternating voltages (e.g., 25 millivolts (mV)) can provide maximum peak resolution. Other forms of voltammetry can also be used that can include, but are not limited to, cyclic voltammetry (CV), linear sweep voltammetry, normal pulse voltammetry, differential pulse voltammetry (DPV), and square wave voltammetry (SWV).

The sensors described herein can include one or more ion sensing probes that recognize a single target ion or, in alternative embodiments, a sensor as described herein can include at least two different ion sensing probes that recognize at least two different target ions. Microarray technology is well known in the art, and can be similarly applied to the placement of ion sensing probes on a sensor described herein.

In accordance with the present invention, there may be employed conventional molecular biology, microbiology, biochemical, and recombinant DNA techniques within the skill of the art. Such techniques are explained fully in the literature. The invention will be further described in the following examples, which do not limit the scope of the methods and compositions of matter described in the claims.

### EXAMPLES

### Example 1

### Materials

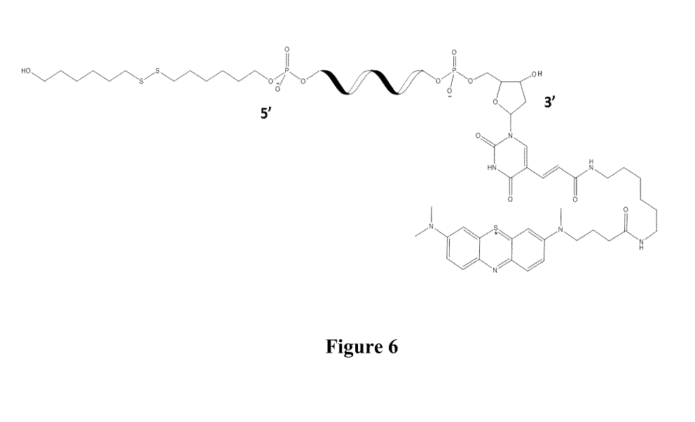

6-mercapto-1-octanol (C6-OH), sodium perchlorate, sodium phosphate monobasic (NaH₂PO₄), sodium phosphate dibasic (Na₂HPO₄), hydrochloric acid, sulfuric acid, cobalt (II) acetate, ZnCl₂, AgNO₃, CaCl₂, MgC₂, lead standard for ICP, chromium standard for AAS, NiCl₂.6H₂O, Mercury (II) nitrate monohydrate, and CuSO₄ were purchased from Sigma (St. Louis, Mo.) and were used as received. Tris-(2-carboxyethyl)phosphine hydrochloride (TCEP) was obtained from Soltec Ventures (Beverly, Mass.) and was used without further purification. The Hg²⁺ sensing probe (T18-LP) with the following sequence was purchased from Biosearch Technologies Inc. (Novato, Calif.) (FIG. 6). The part of the probe designed for Hg²⁺ recognition is underlined; the extra bases at the 3′ end were added to improve probe flexibility.

T18-LP:
(SEQ ID NO: 1)
5′HS-(CH₂)₆-TTT TTT TTT TTT TTT TTT ACT GAT TT-MB 3′

An unmodified DNA strand (TS-11: ±′-CCA GGG TAT CC-3′ (SEQ ID NO:2)) was purchased from Integrated DNA Technologies, Inc. (Coralville, Iowa) and was used in the specificity experiment in the presence of copper (Cu²⁺).

The following buffers were prepared and stored at room temperature (22±1° C.). All solutions were made with deionized (DI) water purified through a Millipore Synergy system (18.2 MΩ·cm, Millipore, Billerica, Mass.). The probe immobilization buffer (Phys2) contained 20 mM Tris, 140 mM NaCl, 5 mM KCl, 1 mM MgCl₂, 1 mM CaCl₂, pH 7.4; and the interrogation buffer (PBS) used in this study contained 8.02 mM Na₂HPO₄, 1.98 mM NaH₂PO₄, 0.5 M NaClO₄ (pH 6.93).

### Example 2

### Instrumentation

Electrochemical measurements were performed at room temperature using a CH Instruments 1040A Electrochemical Workstation (Austin, Tex.). A platinum wire and a Ag/AgCl (3.0 M KCl) electrode served as the counter and reference electrode, respectively. The working electrodes were polycrystalline gold disk electrodes (CH instruments, Austin, Tex.) with a geometric area of 0.0314 cm². Sensor interrogation was performed in a conventional electrochemical cell containing PBS. Four electrochemical techniques, including ACV, CV, SWV and DPV were used in sensor interrogation. AC voltammograms were collected over a wide range of frequencies (1-1000 Hz) with an AC amplitude of 25 mV. CV scans were recorded using scan rates between 0.01-2000 V/s. SWV scans were collected using an amplitude of 25 mV from 1-3000 Hz. DPV scans were recorded over a wide range of pulse widths (1-1000 msec) while maintaining an amplitude of 50 mV.

### Example 3

### Electrode Preparation and Sensor Interrogation

Prior to monolayer formation, the gold electrodes were polished with 0.1 μm diamond slurry (Buehler, Lake Bluff, Ill.), rinsed with DI H₂O and sonicated in a low power sonicator for ˜5 min to remove bound particulates. The working electrodes were then electrochemically cleaned by a series of oxidation and reduction cycles in 0.5 M H₂SO₄. The real area of each electrode was determined from the charge associated with the gold oxide stripping peak obtained after the cleaning process in 0.05 M H₂SO₄ (Angerstein-Kozlowska et al., 1987, J. Electroanal. Chem., 228:429-53).

After the cleaning process, the gold disk electrodes were rinsed with DI H₂O, dried with N₂ and placed directly in a Phys2 solution containing 5 μM T18-LP and 4 mM TCEP for 1 hour. The electrodes were then rinsed with DI H₂O and placed in a 2 mM C6-OH solution for ˜16 hr. All sensor electrodes were pre-treated in 0.5 M HCl for 4 min, followed by a DI H₂O rinse. Prior to target interrogation, the probe-modified electrodes were allowed to equilibrate in PBS for ˜20 min; AC voltammograms were collected at an interval of 5 min until the MB current remained constant. All four electrochemical techniques were used in sensor interrogation. The calibration curves were obtained by sequential addition of increasing concentrations of Hg²⁺ (10, 50, 100, 500, 1000, 2000, and 3000 nM). The sensors were allowed to equilibrate for 55 min after each addition of Hg²⁺ and prior to collecting the voltammograms. Sensor regeneration was accomplished by placing the electrodes in 0.5 M HCl for 4 min, followed by a DI H₂O rinse. At the end of each experiment, the monolayer was desorbed by repeated scanning from −0.2 to −1.4 V at a scan rate of 20 mV/s in 0.5 M NaOH. Post-monolayer desorption, any Hg²⁺ deposited during sensor interrogation was removed by repeated scanning from 0.1 to 0.7 V in 1 M HCl using SWV at 40 Hz with an amplitude of 25 mV.

Sensors were also fabricated on screen-printed carbon (SPC) electrodes purchased from Pine Research (Grove City, Pa.) and CH Instruments (Austin, Tex.). Electrodeposition of gold was accomplished by holding the working electrode at −0.7 V (vs. Ag) for 20 min in a solution containing 1.2 mg/mL HAuCl₄, 1.5 weight % HCl, and 0.1 M NaCl. Sensor fabrication, interrogation and regeneration were performed according to the aforementioned procedure.

The density of electroactive DNA probes on the electrode surface was determined by integration of charges under the MB reduction peak in the CV scans collected at slow scan rates (20, 50 and 100 mV/s) (Gale et al., 1983, Inorg. Chem., 22:130-3). The heterogeneous electron transfer rate (kₛ) for MB was calculated using the Laviron theory as previously reported (Yang and Lai, 2011, Langmuir, 27:14669-77; Laviron, 1979, Electroanal. Chem., 101:19-28). For all “signal-off” sensors, % signal suppression (% SS) was calculated using Equation 1, whereas for all “signal-on” sensors, % signal enhancement (% SE) was calculated using Equation 2.

Signal Suppression(%)=[(I₀−I)/I₀]*100 (1)

Signal Enhancement(%)=[(I−I₀)/I₀]*100 (2)

where I₀ represents the MB current in the absence of Hg²⁺ and I represents the current in the presence of Hg²⁺.

### Example 4

### Selectivity and Specificity Experiments

Sensor specificity was determined by sequential addition of 10 μM of the respective metal ions in the following order: Mg²⁺, Ca²⁺, Zn²⁺, Ni²⁺, Co²⁺, Cr³⁺, Pb²⁺, and Ag⁺. The sensors were allowed to equilibrate in the presence of the specific ion until no change in the MB current was observed. Voltammograms were then collected using all four techniques. 1 μM Hg²⁺ was added to the solution at the end of the experiment to confirm that the sensors were still functional after interrogation with all of the above ions. A separate experiment was performed to evaluate the sensor's ability to detect Hg²⁺ in the presence of Cu²⁺. The sensor was first equilibrated in PBS, followed by the addition of 10 μM TS-11. AC voltammograms were collected until no change in the MB current was observed (˜20 min). 10 μM Cu²⁺ was then introduced to the solution, followed by the addition of 1 μM Hg²⁺.

Two real samples were used in this study. The soil sample was prepared by mixing 1 g of soil with 10 mL of PBS; the sample was stored overnight in the dark. The same procedure was used with the canned tuna sample from StarKist (Chunk White Albacore Tuna in water). The sensors were first equilibrated in PBS, followed by the removal of PBS and addition of the soil or tuna sample. 10 μM Hg²⁺ was then added to each sample after sensor equilibration. The sensors were then regenerated using 0.5 M HCl.

### Example 5

### Sensor Performance in ACV and CV

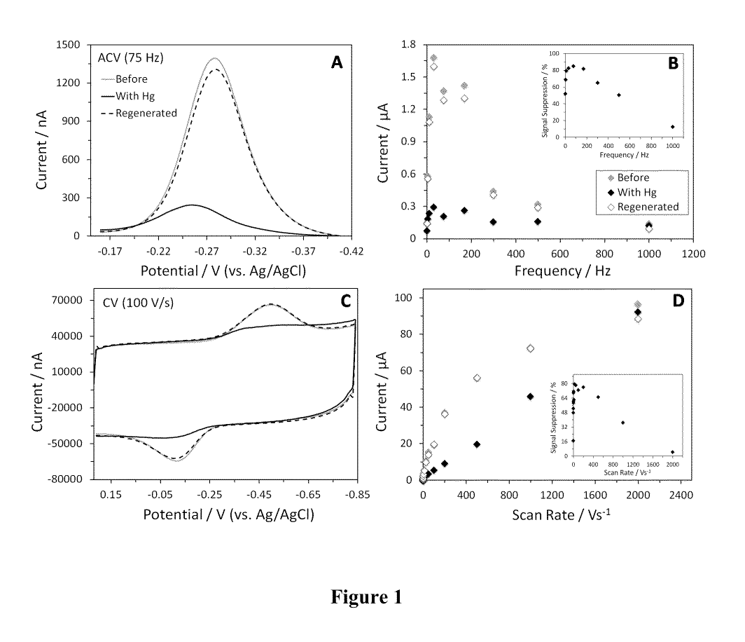

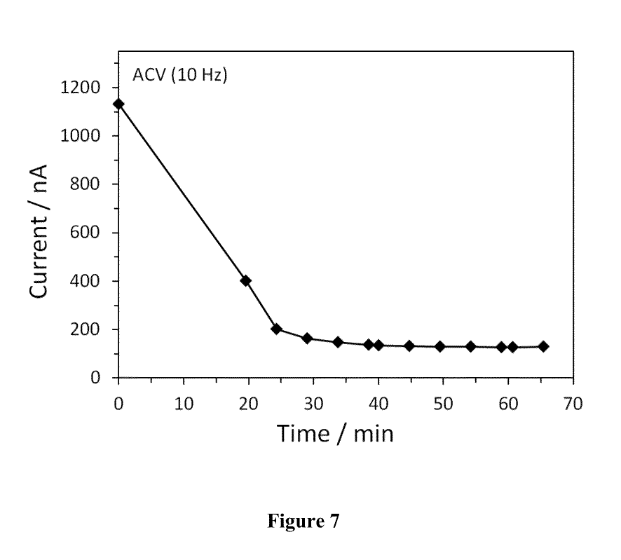

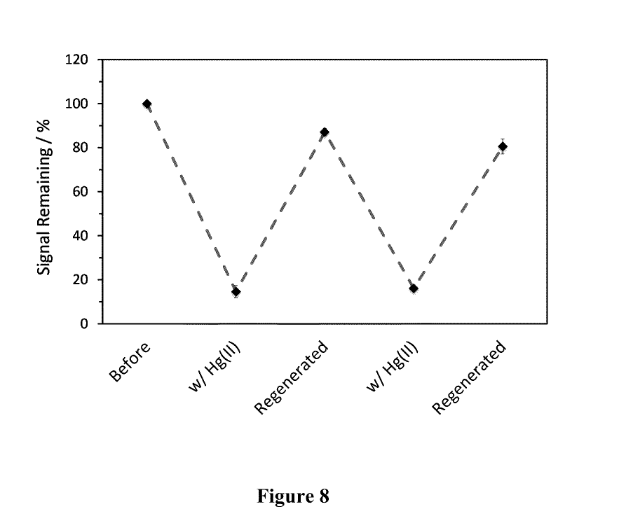

Since ACV is one of the more commonly used sensor interrogation techniques, it was first used to characterize this sensor. In the absence of Hg²⁺, a well-defined MB peak was observed at ˜−0.28 V (vs. Ag/AgCl), a potential consistent with the reduction potential of MB under similar experiment condition (FIG. 1A). In the presence of 1 μM Hg²⁺, ˜83% SS was observed, verifying the sensor's ability to bind to Hg²⁺ via the T-Hg²⁺-T interaction. This “signal-off” behavior is consistent with the kₛ of MB calculated both before and after target interrogation (before: 71±5 s⁻¹; after: 15±3 s⁻¹) using the Laviron theory. The shift in the peak potential to a more positive value could be attributed to the lowering of the pH at the electrode interface, given that the reduction potential of MB is highly sensitive to the local pH (Pyo and Jeong, 1998, Bull. Korean Chem. Soc., 19:122-4). This slight change in the interfacial pH could be, in part, due to the deprotonation reaction that accompanies the formation of the T-Hg²⁺-T complex. Based on previous reports, the specific binding between Hg²⁺ and the T-T mismatched base pair involves dehydration of the structured water molecules surrounding Hg²⁺, followed by the release of the protons at the N3 position of the two T(s). The dehydrated Hg²⁺ can then bind with the two deprotonated T(s) to form the T-Hg²⁺-T complex (Torigoe et al., 2010, Chem. Eur. J., 16:13218-25; Uchiyama et al., 2012, Nuc. Acids Res., 40:5766-74). The sensor responded to the target rather rapidly; majority of the signal change occurred in <20 min (FIG. 7). Similar to other sensors of this class, this sensor is regenerable. We were able to regenerate this sensor using a 4-min incubation in 0.5 M HCl, a regeneration reagent that was not used in previous studies (Liu et al., 2009, Anal. Chem., 81:5724-30; Zhuang et al., 2013, Biosens. Bioelectron., 39:315-9). In this case, protonation of the T(s) destabilizes the T-Hg²⁺-T complex. Acidic solutions such as 0.1 M H₂SO₄ were also used in sensor regeneration, but 0.5 M HCl was found to be the most efficient in destabilizing the T-Hg²⁺-T complex without sacrificing SAM stability. Overall, the regenerated sensor responded well to Hg²⁺, showing % SS slightly lower than that obtained in the first use (FIG. 8).

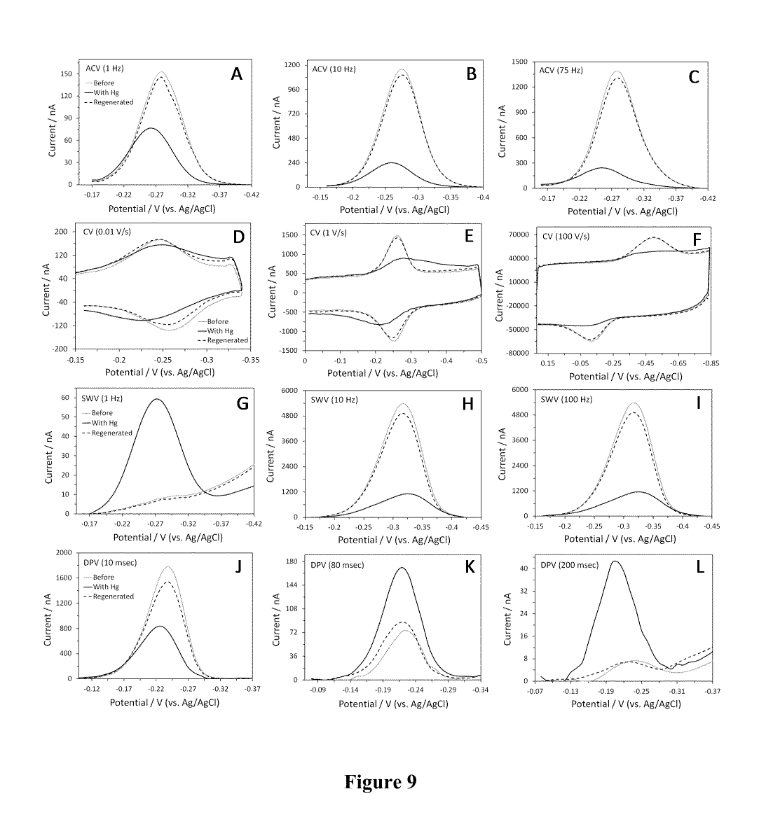

It is worth noting that these results were obtained using the optimized sensor fabrication protocol, in which the probe coverage was relatively high (2.5±0.3×10¹² molecules cm⁻²). A high probe coverage is necessary to maintain good signal attenuation since the ability of the probes to interact with each other via this T-Hg²⁺-T complexation is highly dependent on the distance between the probes. For example, sensors with extremely low probe coverage showed negligible % SS in the presence of 1 μM Hg²⁺. Sensors with extremely low probe coverage are also known to be less stable than those with high probe coverage (Creager and Wooster, 1998, Anal. Chem., 70:4257-63). In addition to probe coverage, the applied AC frequency can also affect the % SS observed in the presence of the target. As shown in FIG. 1B, in the absence of the target the MB current increased with increasing AC frequency, followed by a rapid decrease beyond the threshold frequency (30 Hz). The current continued to decrease at higher frequencies. This behavior is expected since the peak current should be proportional to frequency for a surface-confined reversible redox system where the applied frequency is much lower than the electron-transfer rate. The redox peak current, however, decreases substantially when the applied frequency approaches a critical value above which electron transfer can no longer keep up with the rapidly oscillating potential (Creager and Wooster, 1998, Anal. Chem. 70:4257-63; Summer and Creager, 2001, J. Phys. Chem. B, 105:8739-45). This “threshold” frequency is often an intrinsic characteristic of the sensor architecture. This AC frequency-dependence, while present, was less pronounced in the presence of the target. For this sensor, the optimal sensing frequency range (i.e., 80+% SS) was found to be between 10 and 200 Hz (FIG. 1B). AC voltammograms collected at other frequencies before and after target interrogation are shown in FIG. 9. It is noteworthy that the frequency-dependent current profile of the regenerated sensor was close to identical to that obtained prior to target interrogation, highlighting the effectiveness of the sensor regeneration approach used in this study.

Although CV is most commonly used in sensor characterization, it is an equally good sensor interrogation technique (Yang and Lai, 2011, Langmuir, 27:14669-77; Lai et al., 2013, Methods, 64:267-75). At 100 V/s, a set of redox peaks with a relatively large hysteresis (i.e., peak-to-peak separation) was recorded in the absence of Hg²⁺ (FIG. 1C). In the presence of Hg²⁺, the MB redox peaks diminished substantially, accompanied by a slight change in the hysteresis. Sensor regeneration was equally successful, as evidenced by the overlapping CV scan. An E_{1/2} of −0.26 V (vs. Ag/AgCl) was determined from the CV scan recorded at 1 V/s in the absence of Hg²⁺, this value is comparable to that shown in ACV (FIG. 9). Similar to ACV where the signal attenuation is dependent on the applied AC frequency, the signal attenuation in CV is dependent on the scan rate. As can be seen in FIG. 1D, the MB current increased linearly with scan rate, this increase, however, deviated from linearity at higher scan rates (i.e., beyond 200 V/s). A similar trend was evident in the presence of the target, but the change in current with scan rate was less drastic, thus the smaller slope (FIG. 1D). Best signal attenuation was seen at scan rates between 10 and 200 V/s. CV scans recorded at slower scan rates in the absence and presence of Hg²⁺ are shown in FIG. 9. This sensor, however, is not operational at extremely high scan rates such as 2000 V/s, no signal attenuation was observed in the presence of the target.

### Example 6

### Sensor Performance in SWV and DPV

The signaling motif of this sensor, as shown in ACV and CV, is regarded as “signal-off” (Yang and Lai, 2011, Langmuir, 27:14669-77; Lai et al., 2013, Methods, 64:267-75). Unlike “signal-on” sensors, “signal-off” sensors are, in general, less desirable since only 100% SS can be obtained under any experimental conditions. They are more susceptible to false-positive results since the decrease in redox signal could be due to events other than target binding. It is thus advantageous to identify electrochemical techniques that are capable of converting “signal-off” sensors to “signal-on” sensors when different parameters are used. SWV has previously been used to “switch” innately “signal-off” sensors to become “signal-on” sensors (White and Plaxco, 2010, Anal. Chem., 82:73-6). The theory behind this behavior has been explained in previous works and is not the focus of this study. In brief, at low SWV frequencies the current from the target-bound state is enhanced, the current from the target-free state is suppressed due to the rapid current decay (i.e., fast electron transfer), thereby resulting in a “signal-on” sensor. This approach, however, has not been used with this dynamics-based Hg²⁺ sensor.

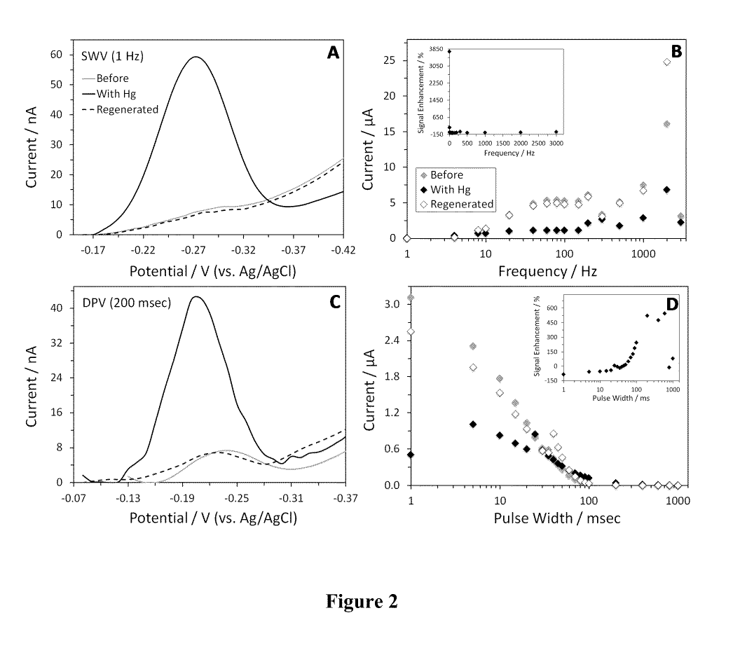

As shown in FIG. 2A, negligible redox current was observed in the absence of the target; a large MB peak, corresponding to ˜3700% SE, however, was recorded in the presence of 1 uM Hg²⁺. This peak was absent post-sensor regeneration. The “threshold” frequency can be determined by analyzing the MB current collected at different applied frequencies, both in the unbound and target-bound states. In the absence of the target, the MB current increased with the applied frequency; the increase was more prominent at frequencies beyond 200 Hz. The MB current became less dependent on the frequency in the presence of the target. As seen in FIG. 2B, the current was higher in the target-bound state when compared to the unbound state only at extremely low frequencies (e.g., 1 Hz). At most frequencies used in this study, the current in the unbound state was much higher; the “switching” frequency was determined to be between 4 and 8 Hz. The optimal frequency range for this sensor to behave as a “signal-on” sensor is relatively limited. The sensor showed “signal-off” behavior at higher frequencies, as indicated by the SWV scans shown in FIG. 9. Nevertheless, the signal attenuation observed at those frequencies was comparable to that recorded in ACV at an optimal frequency. For example, the sensor showed ˜79% SS at 10 Hz, which is comparable to that observed in ACV at the same frequency. Overall, this technique has been demonstrated to be very versatile; the sensor can behave as either a “signal-on” or “signal-off” sensor depending on the applied frequency.

Similar to SWV, DPV has been used as the interrogation technique for a wide range of biosensors; however, it has not been used to convert an inherently “signal-off” Hg²⁺ sensor to become a “signal-on” sensor (Liu et al., 2009, Anal. Chem., 81:5724-30; Farjami et al., 2011, Anal. Chem., 81:1594-602). A small MB peak was evident in the DPV scan before target addition; a large increase in the peak current, corresponding to ˜560% SE, was observed in the presence of 1 μM Hg²⁺ (FIG. 2C). In DPV, both capacitive and faradaic currents are known to be dependent on the applied pulse width. For this sensor system, the MB current was high at shorter pulse widths (e.g., 10 msec), the current decayed rapidly at longer pulse widths. Negligible current was present at pulse widths beyond 800 msec (FIG. 2D). The current decayed in a similar manner in the target-bound state, the change was albeit less drastic. This pulse width-dependent current profile clearly shows two ranges, one where the sensor can be used as a “signal-off” sensor and one where it can be used as a “signal-on” sensor. The “switching” pulse width was found to be between 20 and 25 msec. This “switching” pulse width, similar to the “switching” frequency in SWV, is unique to each sensor design. In this case, the sensor can behave as a “signal-off” sensor at pulse widths between 1 and 20 msec and can be used as a “signal-on” sensor at longer pulse widths (e.g., 200 msec). DPV scans collected at various pulse widths are shown in FIG. 9; these results highlight the sensor's ability to behave as both a “signal-off” and “signal-on” sensor depending on the applied pulse width. It is worth mentioning that higher % SE can be obtained at extremely high pulse widths (e.g., 600 msec), but the scans showed rather “choppy” baseline due to the low current.

### Example 7

### Sensor Sensitivity, Specificity and Selectivity

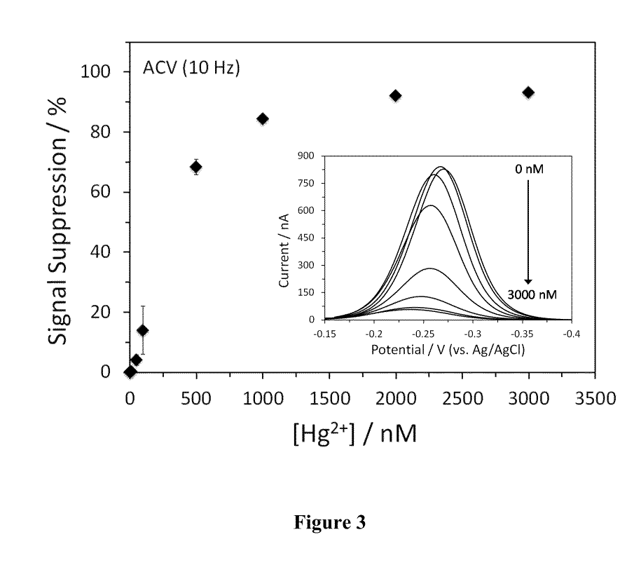

Since ACV was the main sensor interrogation method used in this study, it was first used to determine sensor sensitivity and limit of detection. As shown in FIG. 3, the sensor responded to Hg²⁺ concentrations as low as 10 nM. The sensor showed concentration-dependent response between 10 and 2000 nM, saturating at 3000 nM. In addition to the decrease in MB peak current, the peak potential also shifted to a more positive value, presumably because of the decrease in the local pH (Pyo and Jeong, 1998, Bull. Korean Chem. Soc., 19:122-4; Torigoe et al., 2010, Chem. Eur. J., 16:13218-25; Uchiyama et al., 2012, Nuc. Acids Res., 40:5766-74). These data were fitted to a one-site binding model; the K_{d} was found to be 210 nM. The other three techniques were also used in this study to identify the limit of detection; the results were comparable to those obtained using ACV.

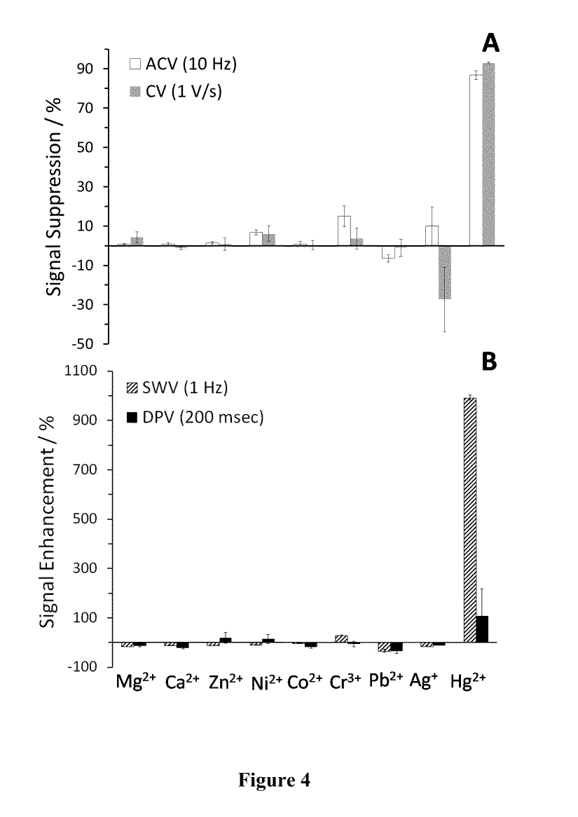

To determine sensor specificity, we interrogated the sensor with different metal ions, including Mg²⁺, Ca²⁺, Zn²⁺, Ni²⁺, Co²⁺, Cr³⁺, Pb²⁺ and Ag⁺ using all four electrochemical techniques. 10 μM of each ion was added to the solution sequentially and the extent of signal change was recorded after the system had equilibrated. 1 μM Hg²⁺ was last added to the sample to confirm the sensor's activity (FIG. 4). In ACV, addition of Ni²⁺, Cr³⁺, Pb²⁺, and Ag⁺ resulted in a slight change in the MB signal. Cross-reactivity with Ag⁺ gave rise to an increase in the MB current in CV; the reason behind this observation is not clear and is currently under investigation. Overall, the results shown here suggest that the sensor is highly specific. The % SS observed with Hg²⁺ was significantly higher than that observed with other ions. Sensor specificity appeared to be further enhanced when SWV was used; the extent of signal change in the presence of all eight ions was much lower than that obtained in the presence of Hg²⁺ (FIG. 4B). For example, addition of 10 μM Cr³⁺ resulted in ˜30% SE, whereas 1 μM Hg²⁺ resulted in ˜990% SE. When compared to SWV, DPV appears to be the inferior “signal-on” interrogation technique due to the lower % SE, but the specificity results were, in fact, comparable to those shown in ACV and CV.

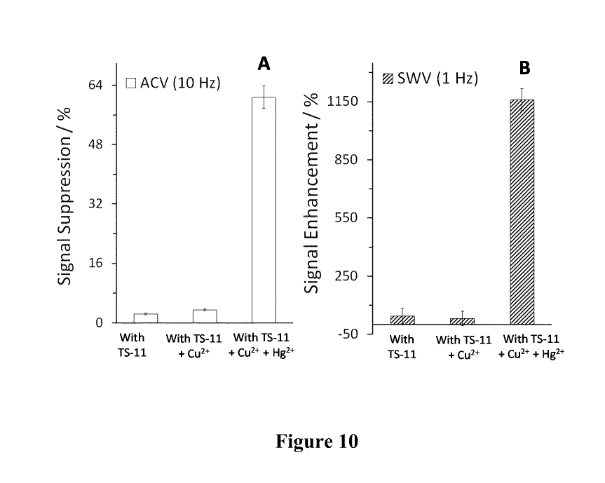

Cu²⁺ is known to interact with T(s), thus, it is entirely possible that it could interfere with the sensing of Hg²⁺ using this sensor architecture (Liu et al., 2009, Anal. Chem., 81:5724-30). As expected, addition of 10 μM Cu²⁺ resulted in % SS slightly lower than that observed with 1 μM Hg²⁺ in ACV. Various methods have been reported to alleviate this issue, including the use of adenine to coordinate with Cu²⁺ in the solution (Liu et al., 2009, Anal. Chem., 81:5724-30). Although DNA has been known to interact with Cu²⁺, short single-stranded DNA has not previously been used for this purpose (Pawlowski et al., 1989, Acta Biochim. Pol., 36:75-85; Maskos, 1979, Acta Biochimica Pol, 26:249-66; Tu and Friederich, 1968, Biochem., 7:4367-437; Eichhorn et al., 1966, Biochem., 5:245-53). Here, we used an 11-base DNA strand (TS-11) to complex with Cu²⁺ in the solution. As shown in FIG. 10A, ˜2% SS was evident upon addition of 10 μM TS-11 in ACV, suggesting the lack of hybridization between T18-LP and TS-11. Addition of 10 μM Cu²⁺ resulted in ˜3.5% SS, confirming TS-11's ability to complex with Cu²⁺. The sensor still responded to Hg²⁺ (1 μM), as indicated by the large % SS. SWV was also used to verify the efficacy of using TS-11 as the complexation reagent (FIG. 10B). A selectivity factor (% SE_{Hg2+}/% SE_{Cu2+}) of 39 was determined for Hg²⁺ even though the concentration of Hg²⁺ was 10 times lower than Cu²⁺. It is worth noting that the concentration of DNA (10 μM) needed to effectively complex with Cu²⁺ was much lower than the concentration of adenine used in a previous study (20 mM) (Liu et al., 2009, Anal. Chem., 81:5724-30).

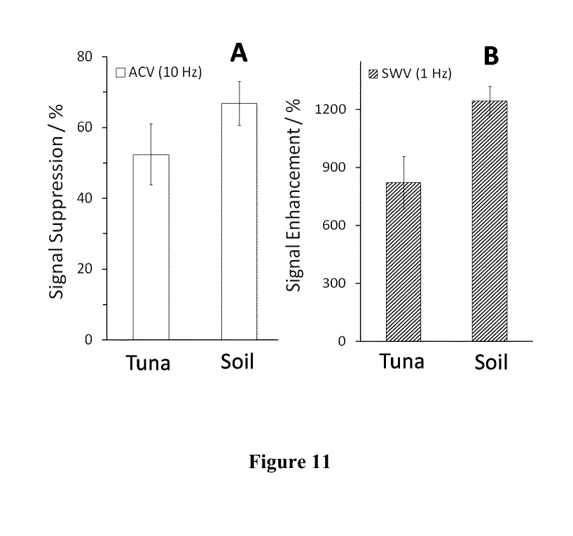

In addition to specificity, sensor selectivity is an equally important factor that governs the sensor's suitability for real world applications (Lubin et al., 2006, Anal. Chem., 78:5671-7; Zhao et al., 2011, Biosens. Bioelectrons., 26:2442-2447). Hg²⁺ can be found in environmental samples such as soil and sea water. Certain fish species such as Bluefin tuna and shark have also been reported to contain a high level of Hg²⁺. In this study, both ACV and SWV were used to evaluate sensor selectivity in two complex samples, including a soil sample and a tuna sample. As shown in FIG. 11, the sensor responded well to the added Hg²⁺ in both samples. The % SS observed in the tuna sample was lower than that shown in the soil sample. This could be attributed to the presence of other anions capable of complexing Hg²⁺ in the sample. The same trend was also observed in SWV; the % SE was lower when the sensor was interrogated in the tuna sample.

### Example 8

### Sensor Performance on Gold-Plated Screen-Printed Carbon Electrodes

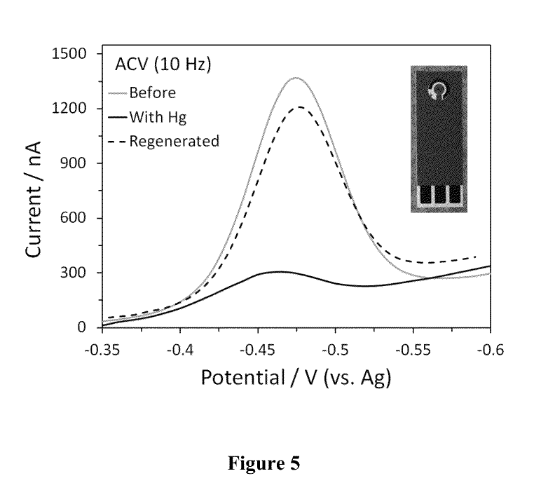

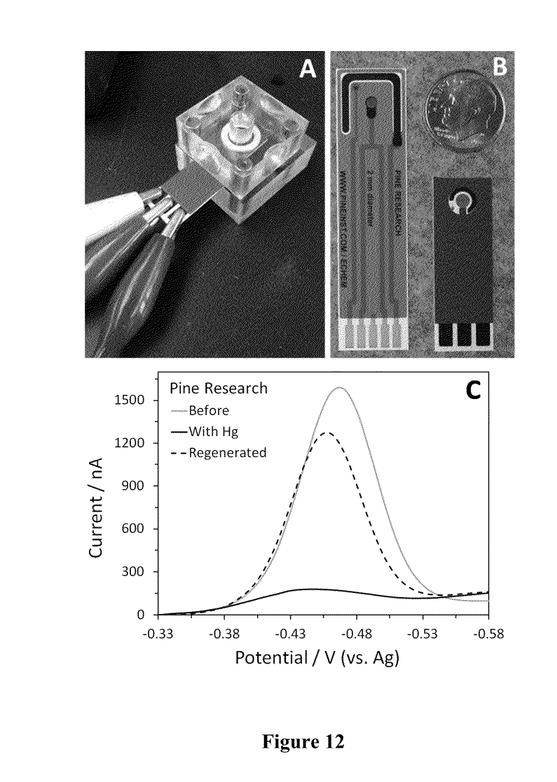

While most sensors of this class were fabricated on gold disk electrodes, there are merits in developing new sensor substrates that are disposable and cost-effective. We recently developed a simple gold electrodeposition method that can be used with SPC electrodes (Yang et al., 2009, Chem. Commun., 20:2902-4). Another advantage of using these gold-plated SPCs is that they can be used with a custom-built electrochemical cell that can accommodate sample volume as low as 40 μL (FIG. 12A). In this study, a thin layer of gold was first electrodeposited onto a SPC by applying −0.7 V (vs. Ag) to the electrode for 20 min. The resultant gold surface was not smooth; the surface roughness factor (real area/geometric area) was 4 and 3 for the Pine Research and CH Instruments SPCs, respectively (FIG. 12B). Despite the surface roughness, the sensors fabricated on these electrodes performed optimally when interrogated using ACV, as evidenced by the large % SS in the presence of the target (FIG. 5). The shift in the MB peak potential to a more negative value is not unexpected due to the use of the on-chip silver reference electrode. Sensor regeneration was reasonably successful; the slight reduction in MB current is probably attributed to the removal of some gold clusters during the rinsing process. The sensor fabricated on a gold-plated SPC from Pine Research also showed similar sensor response (FIG. 12C).

### Example 9

### Four Metal Ion Sensors

We designed and fabricated three metal ion sensors using methylene blue (MB)-modified DNA probes (see below). A thymine-containing DNA probe was used for mercury (Hg²⁺) detection, whereas detection of silver (Ag) was accomplished using a cytosine-containing DNA probe. An adenine-containing DNA probe was used for detecting copper (Cu²⁺). Similar to the linear probe electrochemical DNA sensor, the resultant sensors behaved as “signal-off” sensors in alternating current voltammetry (ACV) and cyclic voltammetry (CV). However, depending on the applied frequency or pulse width, the sensors can behave as either “signal-off” or “signal-on” sensors in square wave voltammetry (SWV) and differential pulse voltammetry (DPV). In SWV, the sensors showed “signal-on” behaviour at low frequencies and “signal-off” behaviour at high frequencies. In DPV, the sensors showed “signal-off” behaviour at short pulse widths and “signal-on” behaviour at long pulse widths. Overall, independent of the sensor interrogation technique, the sensors retain all the characteristics of this class of folding and/or dynamics-based sensors; they are reagentless, reusable, specific and selective. We have demonstrated, for the first time, the use of MB-modified DNA probes for real-time sensing of metal ions in complex samples. In addition to conventional gold disk electrodes, these sensors can also be fabricated on gold-plated screen-printed carbon electrodes, which enables them to be used as cost-effective, disposable sensors for environmental analysis. It would be understood that this sensing motif can be used with other biosensing probes capable of recognizing metal ions (e.g., peptides).

### E-ION Copper Sensor

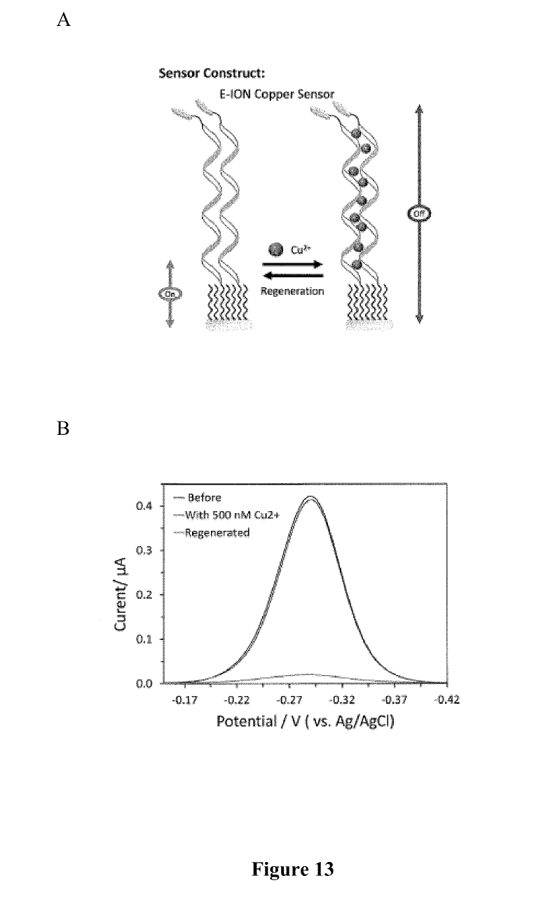

The construct of the sensor is shown in FIG. 13A. The sensing motif was based on adenine interactions with Cu²⁺. The sequence of the probe was 5′ HS-C6-GGC AAA CGC CAC AGC TCC AAA CGG-MB 3′ (SEQ ID NO:3).

The response of the sensor in alternating current voltammetry in the absence or presence of 500 nM Cu²⁺, and after sensor regeneration, is shown in FIG. 13B.

A number of alternate probe designs can be used in this embodiment. For example, 5′ HS-C6/C11-AAA AAA-MB 3′ (SEQ ID NO:4); 5′ HS-C6/C11-AAA AAA AAA AAA-MB 3′ (SEQ ID NO:5); or 5′ HS-C6/C11-AAA AAA AAA AAA AAA AAA-MB 3′ (SEQ ID NO:6).

### E-ION Silver Sensor

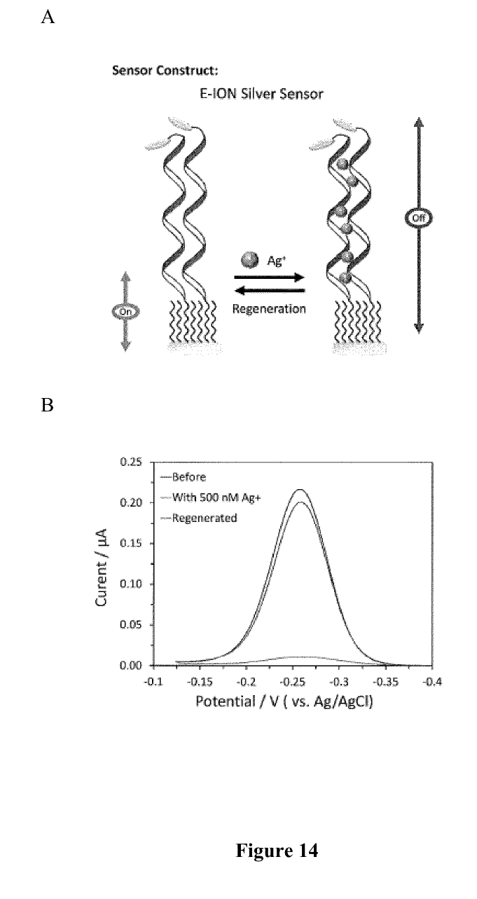

The construct of the sensor is shown in FIG. 14A. The sensing motif was based on cytosine interactions with Ag⁺ (i.e., Cytosine-Ag⁺-Cytosine). The sequence of the probe was 5′ HS-C6-ACA CAC AAC ACA C-MB 3′ (SEQ ID NO:7).

The response of the sensor in alternating current voltammetry in the absence or presence of 500 nM Ag⁺, and after sensor regeneration, is shown in FIG. 14B.

A number of alternate probe designs can be used in this embodiment. For example, 5′ HS-C6/C11-CCC CCC-MB 3′ (SEQ ID NO:8); 5′ HS-C6/C11-CCC CCC CCC CCC-MB 3′ (SEQ ID NO:9); or 5′ HS-C6/C11-CCC CCC CCC CCC CCC CCC-MB 3′ (SEQ ID NO:10).

### E-ION Mercury Sensor

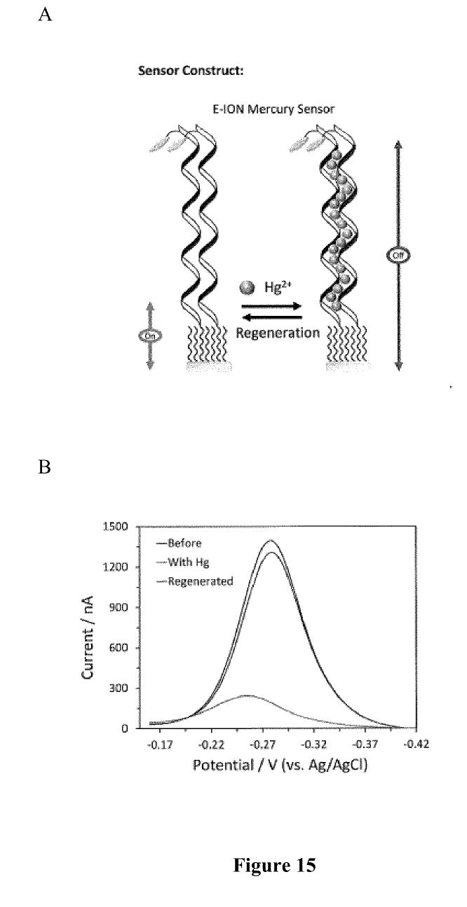

The construct of the sensor is shown in FIG. 15A. The sensing motif was based on thymine interactions with Hg²⁺ (i.e., Thymine-Hg²⁺-Thymine). The sequence of the probe was 5′ HS-C6-TTT TTT TTT TTT TTT TTT ACT GAT T-MB 3′ (SEQ ID NO:11).

The response of the sensor in alternating current voltammetry in the absence or presence of 1 μM Hg²⁺, and after sensor regeneration, is shown in FIG. 15B.

A number of alternate probe designs can be used in this embodiment. For example, 5′ HS-C6/C11-TTT TTT-MB 3′ (SEQ ID NO:12); 5′ HS-C6/C11-TTT TTT TTT TTT-MB 3′ (SEQ ID NO:13); or 5′ HS-C6/C11-TTT TTT TTT TTT TTT TTT-MB 3′ (SEQ ID NO:14).

### E-ION Chromium VI Sensor

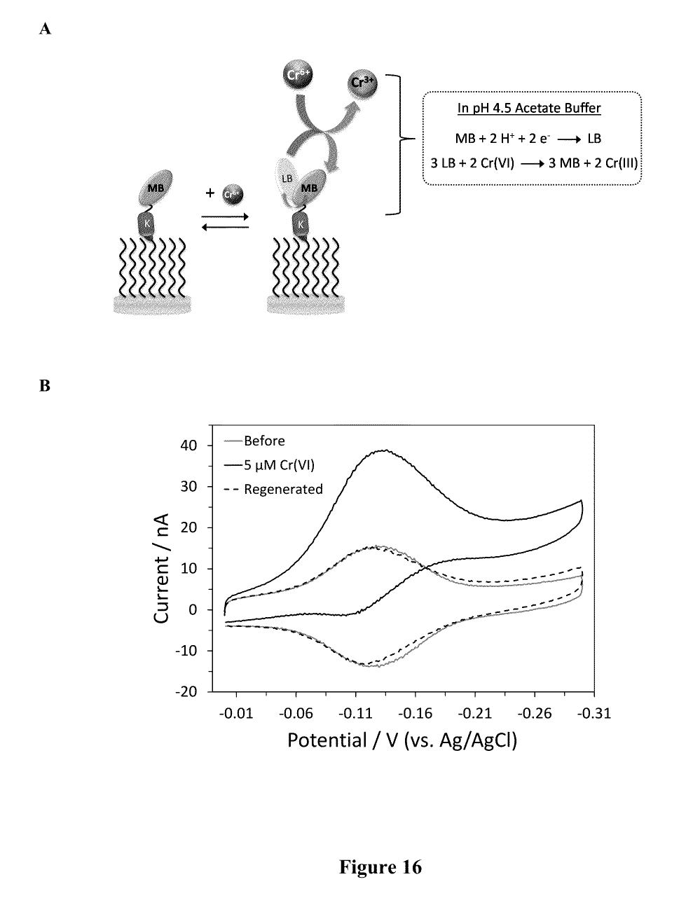

The construct of the sensor is shown in FIG. 16A. The sensing motif was based on the electrocatalytic reaction between Cr⁶⁺ and surface-immobilized methylene blue. The probe that was used was as follows: HS-C6-MB.

The response of the sensor in cyclic voltammetry in the absence or presence of 5 μM Cr⁶⁺, and after sensor regeneration, is shown in FIG. 16B.

A number of alternate probe designs can be used in this embodiment. For example, HS-C6/C11-MB.

It is to be understood that, while the methods and compositions of matter have been described herein in conjunction with a number of different aspects, the foregoing description of the various aspects is intended to illustrate and not limit the scope of the methods and compositions of matter. Other aspects, advantages, and modifications are within the scope of the following claims.

Disclosed are methods and compositions that can be used for, can be used in conjunction with, can be used in preparation for, or are products of the disclosed methods and compositions. These and other materials are disclosed herein, and it is understood that combinations, subsets, interactions, groups, etc. of these methods and compositions are disclosed. That is, while specific reference to each various individual and collective combinations and permutations of these compositions and methods may not be explicitly disclosed, each is specifically contemplated and described herein. For example, if a particular composition of matter or a particular method is disclosed and discussed and a number of compositions or methods are discussed, each and every combination and permutation of the compositions and the methods are specifically contemplated unless specifically indicated to the contrary. Likewise, any subset or combination of these is also specifically contemplated and disclosed.

What is claimed is:

1. An electrochemical sensor for detecting the presence or absence of ions, wherein the sensor comprises a substrate, wherein the substrate comprises:
at least one working electrode comprising an ion sensing probe, wherein the ion sensing probe comprises a redox indicator;
a reference electrode; and
a counter electrode.

2. The sensor of claim 1, wherein the ion is selected from the group consisting of Hg²⁺, Cu²⁺, Mg²⁺, Ca²⁺, Zn²⁺, Ni²⁺, Co²⁺, Cr³⁺, Cr⁶⁺, Pb²⁺, Mn²⁺, Mo⁶⁺, Au³⁺, Pt²⁺, Se⁴⁺, As³⁺, Fe²⁺, Fe³⁺, Al³⁺ or Ag⁺.

3. The sensor of claim 1, wherein the ion sensing probe is selected from the group consisting of nucleic acids, aptamers, and polypeptides.

4. The sensor of claim 1, wherein the redox indicator is methylene blue.

5. The sensor of claim 1, wherein the at least one working electrode comprises gold.

6. The sensor of claim 1, wherein the reference electrode comprises silver.

7. The sensor of claim 1, wherein the counter electrode comprises platinum.

8. The sensor of claim 1, wherein the substrate is paper.

9. A method of detecting the presence or absence of an ion in a sample, comprising:
contacting the electrochemical sensor of claim 1 with a sample; and
obtaining electrochemical measurements to determine whether or not a change in redox potential occurs.

10. The method of claim 9, wherein the electrochemical measurements utilize a technique selected from the group consisting of alternating current voltammetry (ACV), cyclic voltammetry (CV), square wave voltammetry (SWV), and differential pulse voltammetry (DPV).

11. The method of claim 9, wherein the sensor is a signal-on sensor, wherein a change in the redox potential is indicative of the presence of the ion, and wherein no change in the redox potential is indicative of the absence of the ion.

12. The method of claim 9, wherein the sensor is a signal-off sensor, wherein no change in the redox potential is indicative of the presence of the ion, and wherein a change in the redox potential is indicative of the absence of the ion.

13. The method of claim 9, wherein the one or more electrodes are screen-printed onto the substrate.

14. The method of claim 9, wherein the sample is selected from the group consisting of an environmental sample, a food sample, and a biological sample.

15. The method of claim 14, wherein the environmental sample is a soil sample.

16. The method of claim 14, wherein the food sample is fish.

17. The method of claim 14, wherein the biological sample is a blood sample.
